(19) United States
(12) Patent Application Publication
(10) Pub. No.: US 2005/0098497 A1
(43) Pub. Date: May 12, 2005

(54) Pulsating reactors

(76) Inventor: Boris Mikhailovich Khudenko, Atlanta, GA (US)

Correspondence Address: Boris M. Khudenko, 744 Moores Mill Rd., Atlanta, GA, 30327, US

(21) Appl. No.: 10/712,603

(22) Filed: Nov. 12, 2003

(51) Int. Cl. C02F 1/00

(52) U.S. Cl. 210/620; 210/749

(57) ABSTRACT

This is a method and apparatus for treatment of liquid media making use of at least one float positioned at the top of the liquid and at least one gas diffuser placed under the float and connected to this float by at least one brace, the diffuser is connected to a gas source by at least one flexible conduit. The gas emitted from the diffuser produces a mixture with liquid having density lower than the liquid and the float partially sinks in the liquid thus increasing the submergence of the diffuser and lowering the gas flow through the diffuser. At increased submergence, the gas flow is reduced, the mixture density increases, and the float rises. A repeatable motion up and down of the float-diffuser is established producing pulsations in the liquid. The method and apparatus can be used in a multitude of chemical, pharmaceutical, petrochemical, environmental and other industries for carrying out mass transfer, chemical and biological transformations, phase separations, thickening of suspensions, mixing, suspending of particles, washing, coagulation-flocculation, membrane filtration, filtration across particulate media, filtration across floating media, mass transfer across membrane, and other processes.

### FIELD OF INVENTION

The present method belongs to improved processing of materials by applying pulsations to reacting mixtures in chemical, petrochemical, pharmaceutical, environmental and other reactors, wherein the processing may be mass transfer, chemical and biological transformations, phase separations, thickening of suspensions, mixing, suspending of particles, washing, coagulation-flocculation, membrane filtration, filtration across particulate media, mass transfer across membrane, and other processes.

### PRIOR ART

It is well known in the art that the rate and the efficiency of many mass transfer, biological, chemical, and physical-chemical processes dramatically increase when pulsating motion is applied to the processing system Various mechanical and electromechanical sources to induce pulsations had been developed. Often this methods are complex, or expensive.

The main objective of this invention is to provide a simple, inexpensive, and efficient method of inducing pulsations in material processing systems. Other objectives will become apparent from the ensuing description.

### SUMMARY OF THE INVENTION

This is a method for inducing pulsations in a system for treating materials comprising at least one liquid, the system comprising at least one float positioned at the top of the liquid, a gas distribution means for emitting gas in form of bubbles into the liquid, the gas distribution means is positioned underneath at least one float and braced to at least one float by at least one brace, the gas distribution means is flexibly connected to a source of gas by at least one conduit. The method comprises steps of (a) emitting gas at a predetermined initial flow rate from the gas distribution means in said liquid and producing a gas-liquid mixture having density less than the liquid, (b) at least partially sinking the float(s) in said mixture whereby the gas distribution means is submerged to a greater depth and the gas flow rate at the greater depth is reduced, respectively, density of the mixture increases, (c) at least partially rising said floats in said mixture and increasing said gas flow rate, and repeating steps (b) and (c), whereby rising and sinking of said at least one float produces pulsations of said gas distribution means within the range of pulsations, wave-like emission of said gas bubbles, and pulsating motion of said liquid in said system, and whereby said floats and said diffusion means pulsate within a range of pulsations.

The method can also be described as follows. The method of pulsating reacting mixtures with liquid in an apparatus with at least one float and at least one gas diffusion means disposed under said float and connected to the float by at least one brace, the diffusion means is flexibly connected to a source of gas, comprising steps of alternating sinking and floating of said float and said diffuser, whereby, at the upper positions within the range of pulsation, the rate of gas emission by said diffusion means increases and the mixture density decreases causing the float and the diffuser to sink, while at the lower position within the range of pulsations, the rate of gas emission decreases and the mixture density increases causing the float and the diffuser to rise. Periodic sinking and rising create pulsations in the liquid being treated.

The following reaction types and processes can be improved by using pulsations as described herein: mass transfer, chemical and biological transformations, phase separations, thickening of suspensions, mixing, suspending of particles, washing, coagulation-flocculation, membrane filtration, filtration across particulate media, filtration across floating media, mass transfer across membrane, combinations thereof, and other processes as described herein. Mass transfer processes can include gas absorption, gas desorption, aeration, deaeration, adsorption with granular adsorbent, adsorption with powdered adsorbent, adsorption with granular activated carbon (GAC), adsorption with powdered activated carbon (PAC), adsorption by biomass, ion exchange, extraction, combinations thereof, and all other mass transfer processes. The chemical transformations include precipitation, crystallization, dissolution, oxidation-reduction, acid-base conversions, substitution, hydrolysis, polymerization, combinations thereof, and other processes. The oxidation-reduction steps include chemical, electrochemical, biological oxidation-reduction steps, combinations thereof, and other processes. The biological transformations include strictly anaerobic processes, methanogenic processes, sulfur reduction processes, ferric ion reduction processes, fermentationprocesses, acidification processes, denitrification processes, microaerofilic processes, air based aerobic processes, ferrous iron oxidation processes, nitrification processes, oxygen based aerobic processes, combinations thereof, and other processes. The phase separation can be any modification of gravity settling, suspended sludge blanket separation, fluidized bed separation, flotation, combinations thereof, and other processes. The membrane filtration can include filtration with hollow fiber, flat, nano-size, microfilter-size membranes, plastic, metal, ceramic, combinations thereof, and other membrane types.

The gas dispersed by the diffuser can include air, oxygen, nitrogen, nitrogen oxides, inert gases, carbon dioxide, carbon monoxide, sulfur dioxide, hydrogen sulfide, ammonia, chlorine, ozone, organic gases, methane, fuel gas, propane, water vapor, steam, low pressure water vapor under vacuum, reacting gases, nonreacting gases, oxidizing gases, reducing gases, combinations thereof, and other gases. The gases can be a motive agent for producing pulsations and also a reacting agent for supporting any and all described mass transfer, chemical, biological (including disinfection) processes, combinations of this processes, and any other process that can benefit from the present invention.

The sources of gas can be compressors, blowers, vacuum compressor, a vacuum blower, a jet vacuum means, a jet compression means, a tank or a cylinder, or a cistern with compressed gas, and combinations thereof Gas delivery is well known in the art.

The magnitude of pulsations produced by the present method and apparatus is determined by the specific carrying capacity of the float(s), the gas delivery and emission rate, the hydraulic characteristic of the source of gas, the conduit, and the diffusion means, mass and inertia of the system comprising the float, the diffuser, the braces, and the auxiliary elements pulsating with the system, and the density and viscosity of the liquid and liquid-gas mixture. Design of controllable pulsations should follow the known basic procedures established in mechanical engineering practice and applied to the present invention.

The carrying capacity of the floats is determined by the total displacement, or the submerged volume of the floats. This volume divided by the height of the submerged portion of the float can be called a specific carrying capacity. At the same total carrying capacity, floats with smaller width and greater height have lesser specific carrying capacity. Floats with lesser specific carrying capacity produce pulsations of a greater amplitude, or range. Proper selection by a designer of the specific carrying capacity, or the vertical cross-section, of the floats largely determine the pulsations for a given application. The other design factor is the gas emission rate, this factor determines changes in the density of liquid-gas mixture. The vertical cross-section of the floats can be a round section, a vertically elongated section, a vertically elongated rectangular section, a vertically tapered section with wider top, a vertically tapered section with wider bottom, a vertically flat section, shapes with holes and openings, and combinations thereof whereby the range and the frequency of pulsations are substantially determined for a given liquid and for other given elements of the system by said selected cross-sections and the flow rate of gas.

Various applications may require either a single pulsating apparatus or multiple apparatus, more than one float can be combined with a single diffuser, or a single diffuser can be combined with multiple floats. Motion of multiple apparatus or multiple floats or diffuser in a single apparatus may be synchronized or not synchronized. Pulsating apparatus can be installed in an open reservoir, such as tank or pond, or in closed reservoir, including pressurized tanks.

The present pulsation apparatus can be made self-propelled by providing asymmetrical discharge of the gas-lifted liquid from the gas diffuser-float system or other gas-lift system. The self-propulsion can create a circular motion, a linear motion, a reciprocal motion, a motion along a predetermined curve, and combination of various motion paths. The circular motion comprises steps of feeding the gas from the bottom of a vertical standpipe with at least one opening at the top, the vertical stand pipe is cupped with a vertical pipe having open bottom and closed top and at least one essentially horizontal side branch for conducting the gas to the floating and pulsating system, the system having the asymmetrical discharge of the gas-lifted liquid in a predominantly tangential direction relative to the path of the circular motion, whereby the cupping pipe with the branch and with the floating-pulsating system freely rotate around the vertical standpipe. Several floating-pulsating apparatus can be secured to a single branch line, several branch lines can be used, various functional apparatus can be attached to side branches, for example, aeration means, mixing means, gas-lifting and pumping means, biological apparatus of any kind, for example, nitrification cell, solid-liquid separators, and other. Alternatively, the self-propelled apparatus can be provided with a central pile and a rotatably connected arm with the present system attached to the arm and with a source of gas also secured on the rotating arm, for example a compressor which is supplied with electricity by means of rotatable contacts on the central pile.

The reciprocal motion can be provided by alternating steps of terminal switching in the asymmetrical discharge in opposite directions. Asymmetrical discharge can be provided by using flow directing means, such as baffles or other, these flow directing means should be switchable at the terminal, or end, points. The self-propelled motion can follow along directing means, for example, a pivotal structure and at least one arm with at least one pulsating system secured to said arm, at least one linear rail or cable, at least one curvilinear rail or cable, at least one closed line rail or cable, and combinations thereof.

An apparatus for producing pulsation motion can also be described as follows. The apparatus in at least one liquid being treated comprising at least one float, at least one gas diffuser, diffuser is flexibly connected to a source of the gas, the gas is emitted from the diffuser in form of bubbles floating up along a predominantly vertical path wherein the diffuser is connected to the float by at last one brace, and that at least one float is positioned in the path of bubbles emitted by the diffuser, whereby a gas-liquid mixture with varying density is produced and the float and the diffuser are alternatingly sinking and rising in a pulsating manner. This apparatus is used in conjunction with mass transfer, chemical, physical-chemical, and biological transformations, phase separations, thickening of suspensions, mixing, suspending of particles, washing, coagulation-flocculation, membrane filtration, filtration across particulate media, filtration across floating media, mass transfer across membrane, and combinations thereof.

### BRIEF DESCRIPTION OF THE DRAWINGS

FIG. 1 is a basic apparatus with a float, a gas diffuser and a brace for generating pulsations.

FIG. 2 is an elevation of an alternative basic pulsating apparatus.

FIG. 3 is an apparatus with floats, diffuser, and braces that produces no pulsations.

FIG. 4 is an elevation of a diffused air aeration device with pulsations.

FIG. 5 is an example of a pulsating apparatus with contact packing.

FIG. 6 is a pulsating apparatus with hollow fiber membrane filters.

FIG. 7 is an elevation of a pulsating apparatus with hollow fiber mass transfer device.

FIG. 8 is a plan view of the apparatus of FIG. 7.

FIG. 9 is a treatment system including the pulsating apparatus.

FIG. 10 is an elevation of a clarifier with air driven pulsator-earator.

FIG. 11 is a bottom flow distributor for the pulsator-aerator shown in FIG. 10.

FIG. 12 is an elevation of a self-propelled pulsating apparatus with a circular path.

FIG. 13 is a plan view of a self-propelled pulsating apparatus with a circular path.

FIG. 14 is an elevation of a self-propelled pulsating apparatus with a linear-reciprocal path.

FIG. 15 is an elevation of a treatment system with multiple pulsating and self-propelled devices.

FIG. 16 is a plan view of a treatment system with multiple pulsating and self-propelled devices

FIG. 17 is an optional design of a partition in the system of FIGS. 15 and 16.

FIG.18 is another optional design of a partition in the system of FIGS. 15 and 16.

FIG. 19 is yet another optional design of a partition in the system of FIGS. 15 and 16.

FIG. 20 is a plan view of a clarifier with self-propelled and pulsating devices.

FIG. 21 is view along lines I-I in FIG. 17.

FIG. 22 is view along lines II-II in FIG. 17.

FIG. 23 is view along lines III-III in FIG. 17.

### DETAILED DESCRIPTION OF INVENTION

All apparatus described in this section can be prefabricated, easily transported, and easily installed in the treatment tanks. They can also be taken out for repair and easily replaced by repaired or spare units.

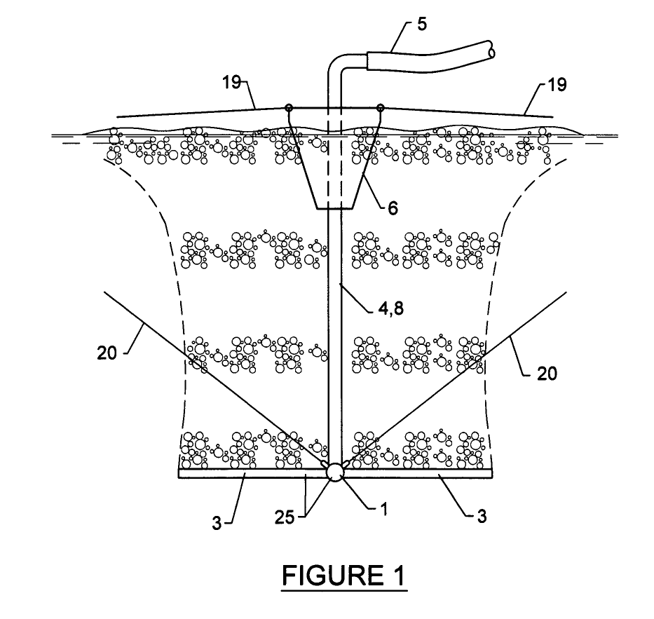

FIG. 1 is an elevation of a basic apparatus with a float, a gas diffuser and a brace for generating pulsations. The apparatus includes a gas distributor made of a manifold 1 and diffuser tubes 2 both making a diffuser 25, manifold 1 is connected by a brace 4 to a cone-like float 6, the brace 4 is simultaneously a gas feed pipe 8 connected to a flexible section 5 leading to a gas source (not shown) such as a blower. Optionally, fasteners 19 and 20 are provided for fixing the position of the pulsation device, for example, in a tank (not shown). The apparatus of FIG. 1 is 5 operated as follows. When gas is fed via line 5 and 4 in the diffuser 25 and the bubbles are emitted upwardly, the space above the diffuser becomes the liquid-gas mixture of a lesser density than liquid. Accordingly, the float 6 sinks down and the submergence of the diffuser 25 increases. The more acute is the angle at the top of the conical float, the further down sinks the system. The pressure outside the diffuser tubes 3 increases and the gas flow decreases, and depending on the design the flow may even stop, thus causing the density of the gas-liquid mixture to increase and the float 6 to rise. This will reinstate the gas flow through the diffuser and a repeatable pulsations of the depicted apparatus will follow. The gas-liquid mixture is gaslifted from the bottom up and flows out in all directions. The gas may flow up in separate waves.

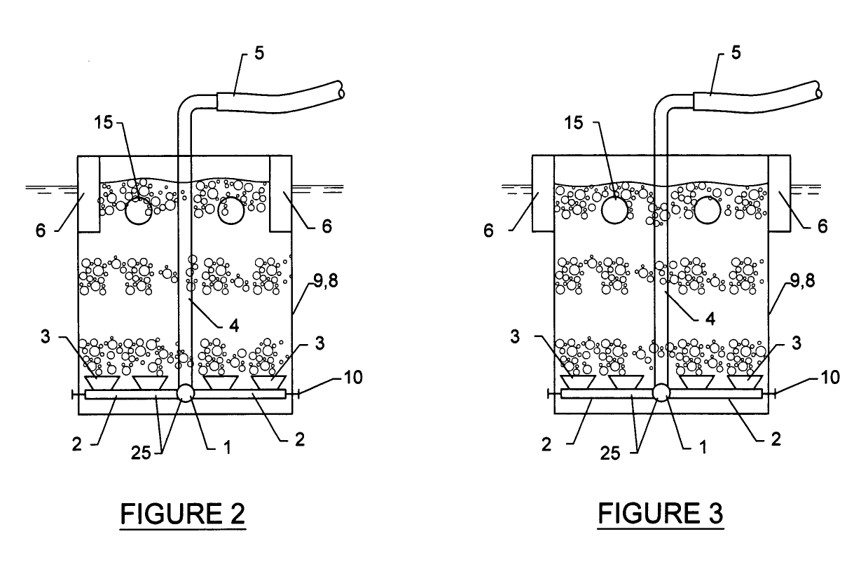

FIG. 2 is an elevation of an alternative basic pulsating apparatus. It has a diffuser 25 comprising a main manifold 1, branch manifolds 2, and diffuser tubes 3. Multiple floats 6 and walls 9 enclosing on four sides the gas filled zone above diffuser 25 are provided. The floats 6 are disposed inside walls 9 and are in the path of the gas flow. At least one of the walls 9 have at least one opening 15 of any convenient and appropriate shape and size. Walls 9 are also used as braces 8 to connect the floats 6 and the diffuser 25 by connecting means 10. The gas is supplied to the diffuser 25 via conduit having sections 4 and 5, section 5 being flexible. The operation of the apparatus of FIG. 2 is very similar to that of FIG. 1 and will not be repeated, with the exception of the gaslifted flow at the top that is directed through the openings 15.

FIG. 3 is an apparatus with floats, diffuser, and braces that produces no pulsations. The apparatus of FIGS. 2 and 3 are almost identical. The single difference is that the floats 6 in FIG. 3 are attached to the walls 9 on the outside and are not in the zone of gas-liquid mixture. Accordingly, they will not produce any sinking and floating motion. Instead, the floating apparatus will rise when gas is fed via diffuser 25 and assume a steady position. The use of cable or rigid rod braces 8 instead of walls 9 also does not produce pulsations, if the floats 6 are not disposed in the path of a significantly aerated (substantial air content) flow, for example, at the outskirts of the aerated zone. It should be stressed that any system with gas diffusion and floats positioned beyond or at the outskirts of the gas-liquid zone will not produce pulsations or significant pulsations. Moreover, pulsations of the desired magnitude require proper shaping of floats and proper selection of the gas flow. Comparison of FIGS. 2 and 3 is given here in order to stress the difference between the present invention and the prior art with floating apparatus.

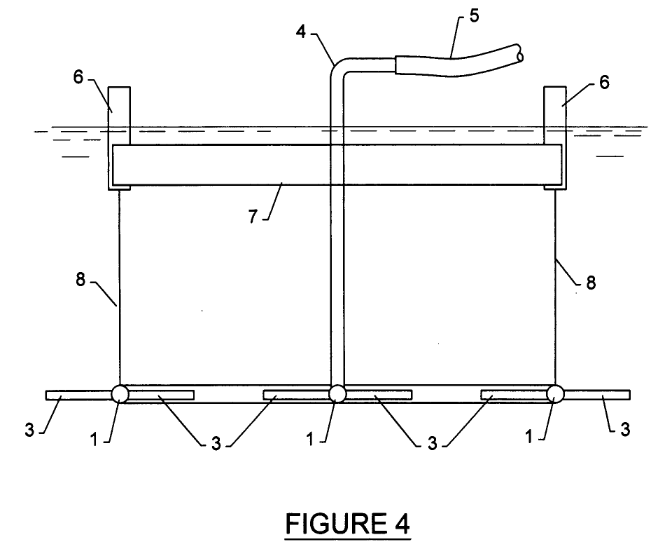

FIG. 4 is an elevation of a diffused air aeration device with pulsations. This embodiment is similar to that shown in FIG. 2, but has no enclosing walls 9 and has braces 8, either rigid (such as rods) or flexible (such as ropes or cables). As shown, the diffuser is made of manifolds 1 connected by side pipes 2 and the tube type aerators 3 secured to the manifolds 1. The braces 8 connect floats 6 to the diffuser. Connecting elements 7 are provided between floats 6. It should be stressed that the floats 6 are positioned in the path of gas bubbles, or within the gas-liquid mixture. The operation of this embodiment is clear from the previous descriptions. The oxygen transfer efficiency (usually expressed in kgO₂/kW-hr) in pulsating aeration apparatus is 20% to 30% greater than in the rigidly supported or floating aeration devices without vertical pulsations. Respectively, 20% to 30% of energy can be saved by using pulsating aerators. This improvement is valid for a wide band or narrow band aeration systems. Floating aerators had been described in the U.S. Pat. Nos. 6,004,456 (FIG. 4 and Col.6, Lines 24 to 26) and 6,478,964. These patents do not describe the method and advantages of pulsation and do not teach how to insure and control pulsations. Accordingly, '456 and '964 provide no advantage in the efficiency as compared to rigidly fixed aerators of the same shape and size. Advantages of the wide band floating aerators over narrow band non-pulsating floating or fixed aerators, and also advantages of off-the-floor aerators as compared to at the floor aerators had been described by Khudenko and Shpirt in “Water Research”, Vol. 20, No.7, 1986, this paper is made part of the present specification by incision.

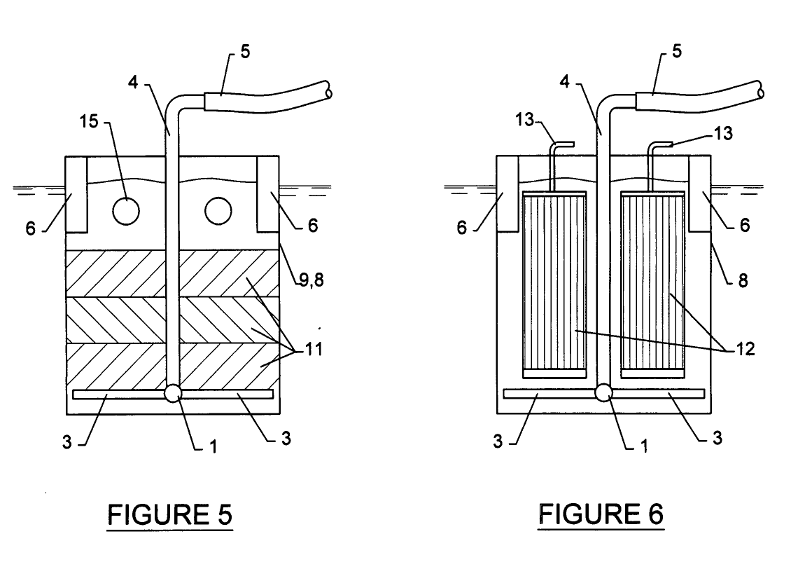

FIG. 5 is an example of a pulsating apparatus with contact packing 11. The diffuser grid comprises a manifold 1 and tube type aerators 3 attached to the manifold. It is clear that diffusers other than tubes can also be used. Other elements are same as described in FIG. 2 and will not be repeated. Packing 11 can be made from cross-flow blocks made with fused corrugated sheets having inclined waves, or of flat, rigid, or flexible sheets, or the packing can be in form of various rods, balls, hollow balls, plastic or other mesh, fuzzy balls made of fibers, and any other packing. The apparatus can be used in many applications, for example for attached biological growth processes such as anaerobic, aerobic, nitrification processes, and other. The pulsations increase the turbulence and the drag force at the surface of the packing. The rate of transport (convection and diffusion) of materials reacting and produced at this surface increase. Accordingly, the overall process rate and efficiency increase. Pulsations also produce self-cleaning of packing from solid matter accumulating on reacting surfaces. Packing in combination with pulsation apparatus can also be used for other purposes, for example U.S. Pat. No. 4,472,358 describes packing for improved solid-liquid separation, particles aggregation and flocculation, improved mixing in biological physical-chemical and biological reactors, and other applications. This patent is made a part of the present specification by inclusion.

FIG. 6 is a pulsating apparatus with hollow fiber membrane filters 12. Other elements are same as described in FIG. 2 and will not be repeated. Membranes 12 can be made from hydrophobic or hydrophilic materials, they may have pore in nanopore size or micropore size range, or in other ranges. The outlets 13 for filtrate are provided. The apparatus can be used in many applications, for example for water purification in public and industrial water supplies, in treatment of industrial and municipal wastewater, including biological treatment, in treatment of beverages, and in chemical processing. The pulsations increase the turbulence and the drag force at the surface of the fibers, and increase the transport rate of reacting or separating species and products, thus increasing the total process rate. Pulsations also produce self-cleaning of fibers from solid matter accumulating on filtration surfaces.

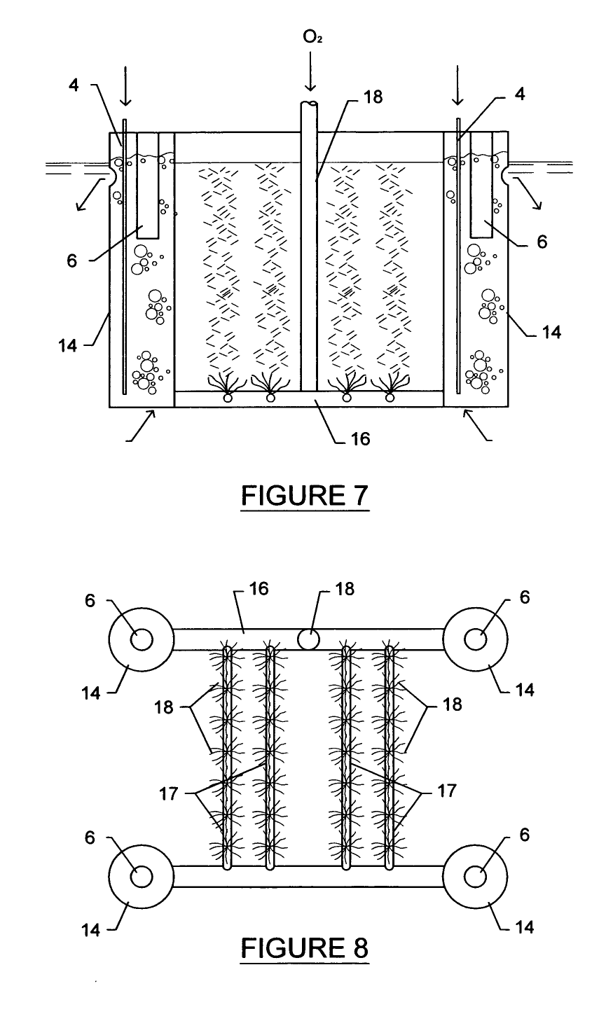

FIG. 7 and 8 show an elevation and a plan view of a pulsating apparatus with hollow fiber used for gas mass transfer. The system has a grid of pips 16 and 17. Lumens of tubular (hollow) fibers 18 are attached to the pipes 17 and communicate with these pipes. The outer ends of the fibers are closed. four pulsating apparatus with circular body 14 are attached to the grid of pipes 16 and 17. The pulsating apparatus exemplified here has a body 14 with floats 6 secured to the body 14 at the top, and a gas diffuser 4 in form of a pipe 4 flexibly connected at the upper end to a source of gas (not shown) with the lower open end submerged in the body 14. Body 14 has an opening 15 for discharge of the gas-lifted liquid. Tubular fibers have pores in the walls of 0.1 to 1.0 microns, so that very small bubbles can be produced. U.S. Pat. No. 5,674,433 teaches that a flow of liquid needs to be produced to dislodge the bubbles leaking from the pores so that the bubbles departing in the liquid will be small. This embodiment is operated as follows. When gas is supplied through the diffusers 4, the pulsations are generated as previously described. These pulsations induce liquid flow at the surface of tubular fibers and shake, bend, and twist the fibers, thus intensifying the detachment of small bubbles formed at the surface of the fibers 18. The described embodiment can be used in pharmaceutical processes for aerobic fermentation, in water and wastewater treatment, and many other processes. In many applications, the gas fed through the hollow fibers can be different from the gas fed into the pulsating apparatus, for example, oxygen can be preferably fed via hollow fiber and air through the pulsating apparatus.

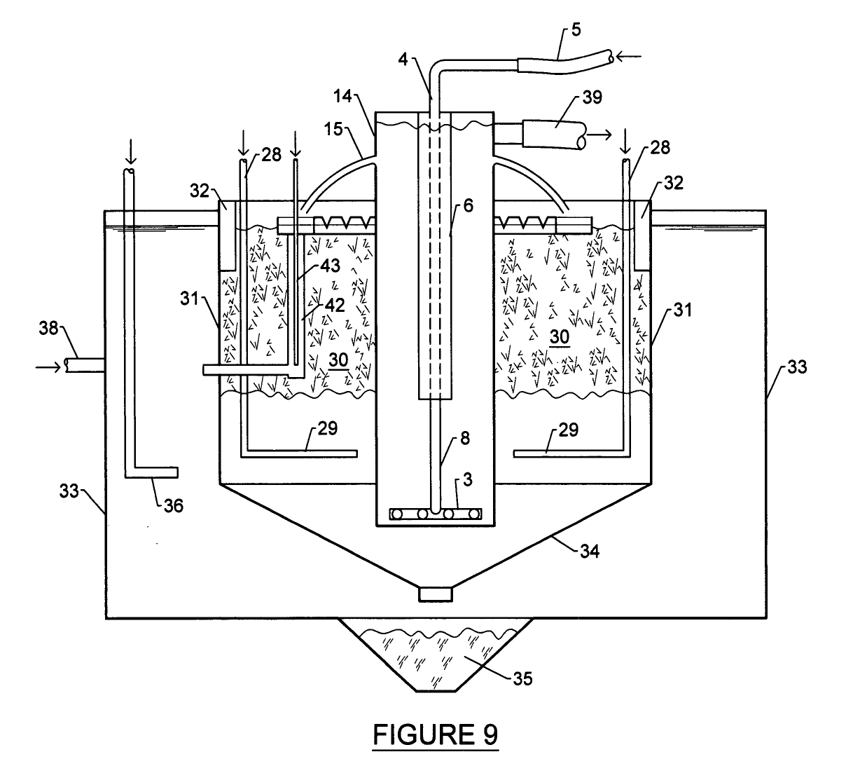

FIG. 9 is an elevation of a combination of a pulsating apparatus with a treatment system that can be adapted and/or modified for chemical or biological processes, mass transfer, mixing, filtration, upflow suspended sludge blanket clarification, fluidized bed reactors, and other applications. The treatment system includes the pulsating apparatus comprising a body 14 with a diffuser 3, a float 6, a combined brace and the gas (air) feed pipe 4 (8), a flexible gas conduit 5, and discharge orifices 15 for gaslified liquid. The pulsating apparatus is fastened (fasteners are not shown) to a first treatment apparatus that, as shown, is floating rectangular, polygonal, or circular filter delimited by a wall 31 with floats 32 attached to the wall, the filter is provided with a floating bed 30, at least one additional aerator 29 under the floating filter bed 30 with air conduit 28 is provided. Aerator 29 is disposed under the floating filter bed 30. A liquid distribution means, for example, a concentrical liquid distribution flume 41 is provided at the top of the bed 30. At least one gaslift (airlift) 42 for feeding liquid from the second treatment tank (see below) to the first treatment tank with a gas (air) feed line 43 is also provided. The first treatment tank is provided with preferably conical or pyramidal bottom 34 having a solids discharge opening 42. In the basic modification, the treatment system is further provided with a secondary treatment tank 33,that is also a containment tank, optionally having conical or pyramidal sections 35 at the bottom 40. Optionally, tank 33 is provided with at least one aerator 36 with air line 37. The influent line 38 may be provided in the side wall of tank 33, and the effluent line 39, optionally with a flexible connection (not shown) is attached to the top of the body 14. Optionally, aerators 29 are disposed under floats 32. Optionally, the body 14 and the walls and the bottom of the first tank can be made of light weight materials, for example plastics, including substantially thin and light flexible plastic with light metal or plastic framing.

The operation of the embodiment of FIG. 9 is illustrated for biological filtration of wastewater through floating media made of material slightly lighter that water, for example polyethylene or polypropylene. The influent is fed in the second vessel 33 and treated using biomass grown in the process. By air supplied through the aerator 36, at least one aerobic zone is established in the first tank. Optionally, zones with anoxic, fermentation (acidogenic), and anaerobic (such as methanogenic) can also be established. Particularly, predominantly aerobic conditions will be created above and near the aerators 36, anoxic conditions may develop at a distance from aerators, yet even further, fermentation (acidogenic) zone arise. Strictly anaerobic zones may develop in zone 35. Alternatively, aerobic, anoxic, fermenting, and anaerobic conditions can be developed due to heterogeneity of the biomass, including the use of attached growth biomass. The latter can be provided by using either fixed or floating attachment media in the second tank 33. The liquid being treated can be exposed to all these conditions and to respective sludges (biomass types) by appropriately directing the liquid and biomass flows withing the first tank. Directing the flows can be accomplished by mixing withing the tank due to aeration, by airlifting liquid and biomass as desired, and by using any other means liquid transport, mixing, and delivery means known to skilled in art. The liquid treated in the second tank 33 is transferred into the first tank 31 via transfer means, for example airlift 42 with the air feed line 43. The transferred flow is fed in the distribution ring 41, overflows into the floating bed 30, filters through the bed 30, wherein further biological treatment occurs by the attached biomass growing on the bed packing, The air is fed via flexible line 5 and line 4 into the diffuser 3 and flows up in the body of the pulsation apparatus 14. This air draws liquid from underneath the bed 30 and produces multiple recycles of this liquid through bed 30. The airlifted liquid is discharged from orifices 15 onto the liquid distribution ring 15 and mixed with the liquid transferred from the second tank via airlift 42. The filtered water is discharged from the treatment system via line 39, optionally a flexible connection. The air passage around the float 6 produces vertical pulsations which improve the contact between biomass and the pollutants in the bed 30, and respectively the process rate in the bed 30. Gradually, biomass accumulates in the packing of the bed 30 and it needs to be regenerated (washed). In case of floating bed as described above, simple air feeding via aerators 29 will largely dislodge the accumulated solids. Only a thin layer of biomass will be retained and will serve as a seed for the further treatment. When air is fed via aerators 29, the density of the gas-liquid mixture in the bed becomes less than the density of polyethylene (polypropylene) particles and the particles sink and move relative each other, get involved in the bubble wakes and otherwise mechanically disturbed. Dislodged solids sink below the bed 30, slide along the bottom 34 and become evacuated in the section 35 of the second tank 33.

The embodiment of FIG. 9 can be added with a clarification zone, several steps of the first tank 31 or several steps with repeated system as shown in FIG. 9 can be devised by skilled in arts.

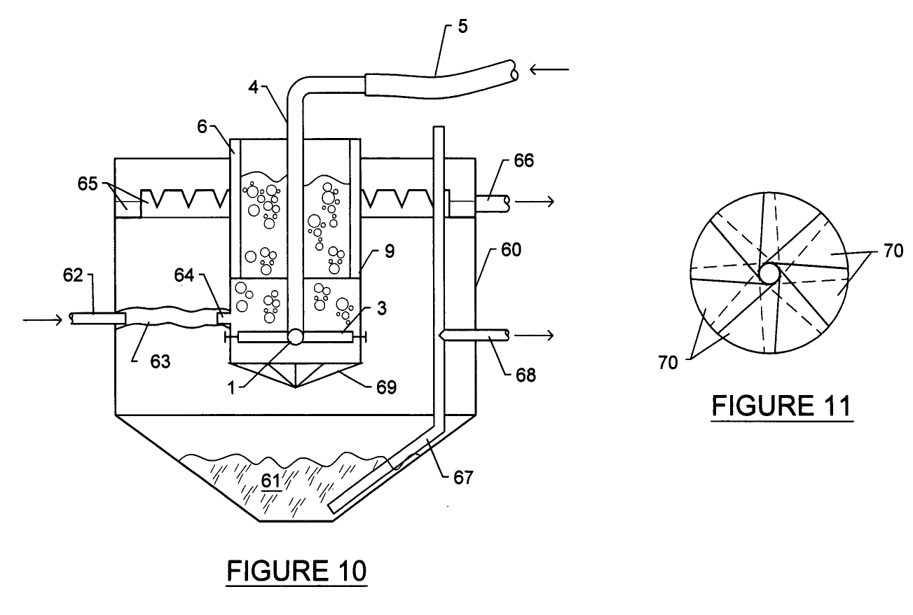

FIG. 10 is an elevation of a clarifier with air driven pulsator-earator. It includes a clarifier body 60 with a sludge zone 61, an influent line 62connected to the built-in pulsator-aerator 9 by a flexible pipe 63 and connector 64. It is clear to all skilled in arts that other connections, for example by a pipe run over the top of the system can also be used and such a minor change cannot be considered an invention. The clarifier is also provided with a sludge removal and sludge discharge pipes 67 and 68, with the trough for collecting clarified effluent 65 and the effluent pipe 66. The pulsator-earator includes a manifold 1 with aeration diffusers 3, the air supply pipe 4 and a flexible section of air pipe 5, the structure is supported by floats 6 inside the walls of the pulsator-aerator 9.

The embodiment of FIG. 10, a clarifier, is operated by feeding the influent, for example a primary wastewater influent after screening and grit chambers, or a mixed liquor after any kind of biological treatment, via line 62, flexible pipe 63 and the connector 64 in the pulsator-aerator 9, feeding air via flexible line 5, pipe 4, collector 1, and air diffusers 3 in the pulsator-aerator, producing air bubbles in the pulsator-aerator and inducing the vertical pulsations due to changes in the carrying capacity of floats 6. The aerated liquid would flow out from the pulsator-aerator from the bottom, optionally through a flow distribution device, particularly, a device capable of rotating the contents of the clarifier. Such device 69 can be made in form of iris plates 70 as shown in FIG. 11. Plates 70 are connected at the center and twisted such a way that a water passages is provided and water is directed tangentially. The liquid transferred from the pulsator-aerator flows up in the annular zone between the clarifier wall 60 and the pulsator-aerator wall 9, the particles in the water are settled down in zone 61 and periodically or continuously removed via pipes 67 and 68. The clarified water is collected in the trough 65 and evacuated via line 66. The pulsator-aerator improves saturation of water with oxygen, provides efficient stripping of carbon dioxide, and significantly precipitates heavy metals, provides significant biological treatment, and improves clarification by better flocculation in a pulsating flow. The rotations with the use of iris devise 69 further improves water distribution in the clarification zone and improves solids removal efficiency. It is understood that various designs of pulsator-aerators can be built-in various settling tanks and clarifiers. Those pulsator-aerators may be a single elongated floating channel with aeration submerged in an elongated settling tank, for example a clarifier with horizontal flow, or any modification of Imhoff tank. Multiple pulsator-aerators can be installed in a single settling (or clarification) tank.

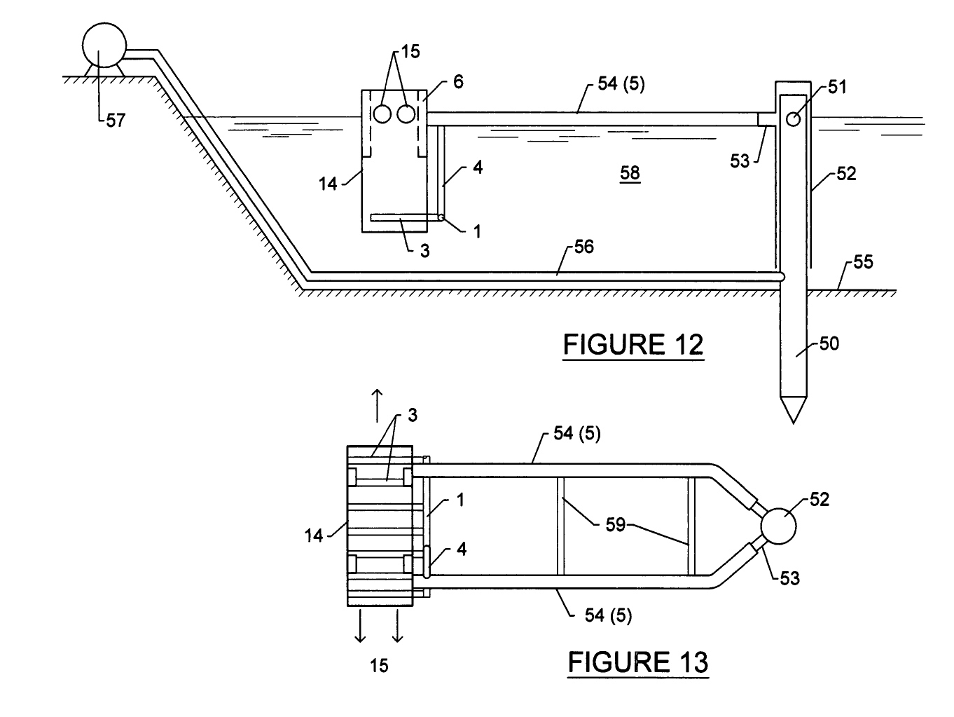

FIG. 12 is an elevation and FIG. 13 is a plan view of a self-propelled pulsating apparatus with a circular path. Other self-propelled aerators are described in the US Patent No. 4,482,510 and the USSR Certificate of Invention No. 726027, both are made parts of the present specification by inclusion. As an example, installation in a treatment pond is described. It is understood that such a device can be used in many other reservoirs. It includes a blower 57, outside the pond 58, a flexible or rigid air line 56 run at the bottom, or under the bottom, a central pile 50 made as a hollow pile (a standpipe) having an air outlet 51 (the open top of the pipe 50 can be an air outlet), an outside pipe 52 with closed top and at least one side outlet 53, at least one flexible or semi-flexible arm 54, and the aeration device of FIG. 4 description of which is not repeated. The arm 54 can be preferably made of a semi-rigid plastic pipe or other pipe capable of absorbing vertical pulsations of the aeration device and any waves in the pond. Pipe 54 can be made of a sequence of rigid and flexible or semi-flexible sections. It has to be sufficiently rigid to keep the aeration device at the predetermined distance. Parallel twin-semi-flexible pipes 54 floating on the water surface and connected by perpendicular rigid spacers 59 as shown in FIG. 13 would make an acceptable floating frame to keep the predetermined distance between the pulsator 14 and the central pile 50. The operation of the aeration device is the same as previously described. The water discharge from the top of this devise must be asymmetrical and produce a greater outflow in one direction perpendicular to the arm 54. In FIG. 12, such outflow is provided via openings 15. Openings can be provided in any direction, but the resultant momentum of forces must insure the rotation Accordingly, the devise will self-propel itself around the pile 50, with the device itself floating and pulsating on the surface, the semi-rigid arm preferably floating on the water surface (alternatively, it can also be supported by floats), and the outside pipe 52 will rotate around standpipe 50. The water level in the annular space between pipes 50 and 52 will be lower then the elevation of the air diffusers by the hydraulic losses in the arm 54, line 4, and the diffuser 3. The arrangement of pipes 50 and 52 with outlets 51 and and 53 and inlet 56 form a hydraulic lock capable of conducting air to a floating rotating device from a “shore” without any complex mechanical means. The self propelled devise can be used for aeration, nitrification, and other purposes. An impingement jet-aerator on floats with airlift pumping of water can be used instead of the described diffused air aerator. The main advantage of the self-propelled devise, as compared to stationary aerators sized for mixing in ponds, is in about four fold greater mixing service area per a unit of the same power. The energy demand can be reduced four-fold or greater. At the same time, a combination of aerobic, anoxic, and anaerobic conditions can also be provided and easily controlled. Various devises can be attached to the rotating arm of the self-propelled pulsating aerator, for example, a packed media nitrification devise, a mixer for anaerobic zones, a drive for sludge collectors.

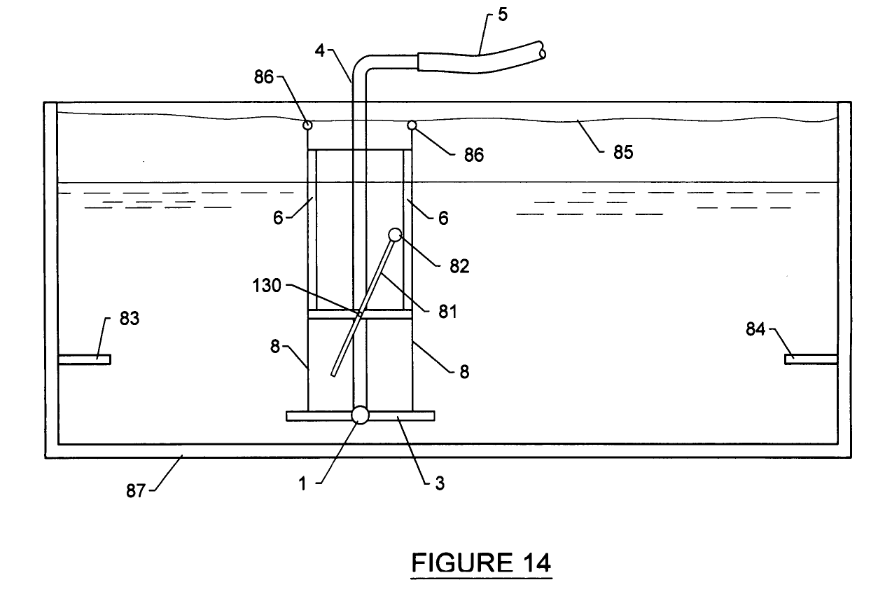

FIG. 14 is an elevation of a self-propelled pulsating apparatus with a reciprocal path. The already described pulsation aeration device of FIG. 4 is added with a hinged baffle 81 having a hinge 130 and a counterweight 82, the system is further added with at lest one directing cable 85, and braces with loops 86 embracing the cable 85 and freely sliding along the cable 85, and the left, 83, and the right, 84, motion reverse means, for example, fixed in place rods. The width of the inclined baffle may be equal to the total width of the aerating device or it can equal only a portion of the total width When the baffle is inclined as shown in FIG. 12, the entire aerating device slides leftward due to the deflection of at least a portion of the airlifted flow by inclined baffle. At the leftmost position while the aerating device keeps moving, the baffle 81 strikes the rod 83 and turns around the hinge 139 and is fixed in the new inclined position by counterweight 82. In this position of the baffle 81, the airlifted flow is deflected leftward and the device moves rightward till the baffle strikes the rod 84 at the rightmost position and the direction of the motion is reversed again. It is understood that skilled in arts can provide many alternative solutions to propelling and reversing mechanisms, change cables for rails, and so on. Such changes can be more appropriate for particular engineering designs. This does not change the present inventive principle.

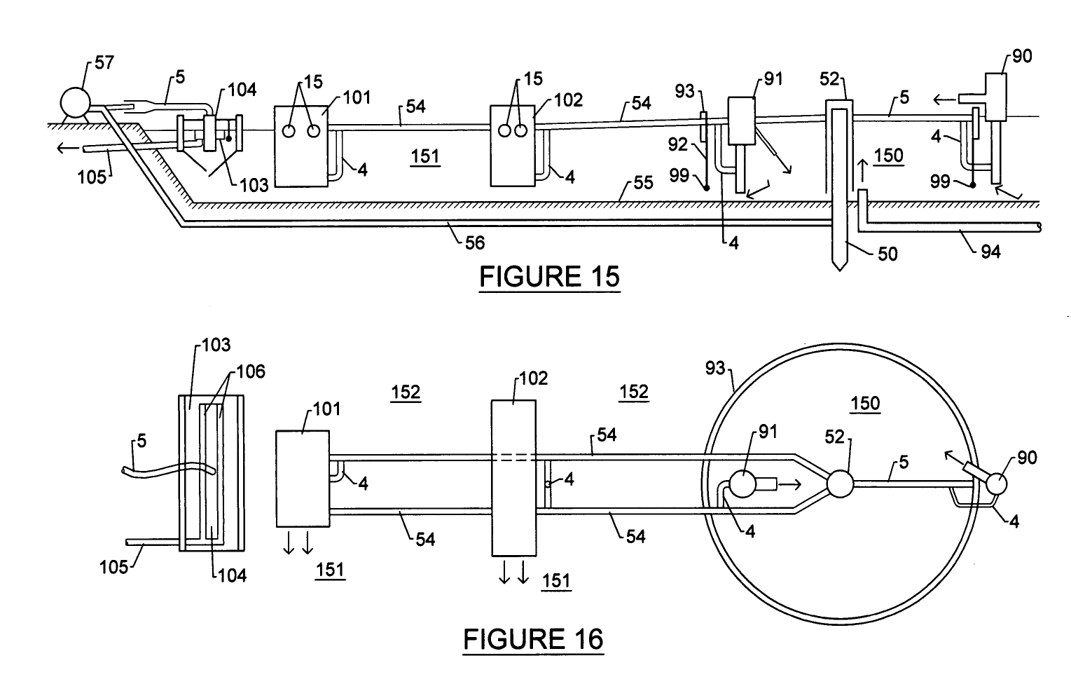

FIG. 15 is an elevation and FIG. 16 is a plan view of a treatment system with multiple pulsating and self-propelled devices. This system is a further development of the system shown in FIGS. 12 and 13. It has an aeration-pulsation device 101 and, optionally, a nitrification device 102 with packing as previously described. It is also provided with a circular floating baffle 92 with floats 93, and bottom weights 99. Preferably, baffle 92 is made of a flexible material, such as plastic. The baffle 92 is attached to the floating semi-flexible arms 54 and 5. The arms 54 and 5 and the floats 93 determine the shape of the essentially circular shape of the baffle 92 and fixed it in place relative the central pipe 50. An airlift mixing device 91 with air supply line 4 is provided. The mixing device 91 comprises a vertical pipe of a constant or variable diameter and a side discharge that can be inclined as shown or horizontal. An airlift 90 for mixed liquor recirculation is provided. Design of the airlift is similar to that of the mixing device. A floating clarifier 103 of the Imhofftype with a pulsating-aerating means 104 and a collection means 106 and the discharge line 105 is also provided. An influent pipe 94 is provided. Optionally, an influent pipe can be provided in zone 151 and 152. Influent can also be split between zones 150, and/or 151, and/or 152. The entire volume of the system includes an anaerobic zone 150 inside the baffle 92, aerobic zones 151 on the side of discharge from units 101 and 102, and anoxic zones at the opposite side of units 101 and 102. It is understood that aerobic and anoxic zones are “moving” with the rotations of the apparatus 101 and 102. Optionally, the effluent recycle lines may be provided into zones 150, and/or 151, and/or 152. Many modifications of biological and abiotic treatment steps and combinations thereof are described in the U.S. Pat. Nos. 5,514,277, 5,514,278, 5,616,241, 5,798,043, 5,846,424, 5,919,367, 6,004,456, 6,015,496, 6,048,459, 6,220,822, these patents are made parts of the present specification by inclusion.

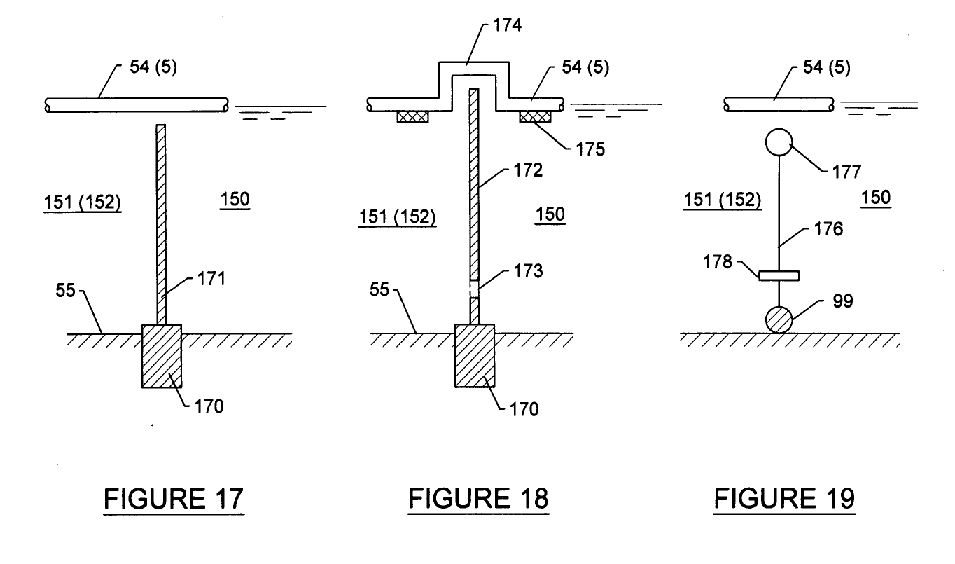

The system of FIGS. 15 and 16 is operated as follows. The influent wastewater is fed via line 94 in the anaerobic zone 150. Anaerobic zone can be operated as fermentation, acidogenic, sulfate reduction, methanogenic, ferric ion reduction, or other zone with a substantial reducing potential. Optionally, a sludge conditioning zone for growing methanogens, and/or other microorganisms, can be provided. Anaerobic zone is optionally mixed by mixer 91. Optionally, an upflow sludge blanket can be provided in this zone. As a rule, low strength wastewater, for example domestic or municipal should be subjected to fermentation oracidogenic treatment in zone 150, although other anaerobic steps can also be used. Highly concentrated wastewater should be subjected preferably to a stronger anaerobic (reduction) action, for example methanogenic. Anaerobic process steps reduce BOD and COD in soluble and suspended solid forms with low biomass generation and low energy demand. Residual organics from the anaerobic process steps include volatile fatty acids (VFA) and anaerobic biomass. The wastewater with the residual organics flows under baffle 92 in the largely anoxic zone 152 and further in the aerobic zone 151. Aeration-pulsation devise 101 aerates wastewater, periodically re-suspends the biomass and reduces BOD and COD via oxygen oxidation, the aerated mixed liquor is discharged in zone 151. The attached growth nitrification-pulsation apparatus 102 makes use of the slow growing nitrification biomass attached to the packing in apparatus 102, this biomass and wastewater passing across the packing are aerated, wastewater is airlifted through the biomass and is discharged into zone 151. Gradually, oxygen is consumed in zone 151 and it becomes an anoxic zone 152. Biomass at least partially settles in zone 152. A portion of the mixed liquor from zones 151 and 152 is recycled back in zone 150 via airlift 90. The mixed liquor is divided into the clarified effluent and sludge in the clarifier 103. This clarifier is provided with pulsating device 104. Sludge falls down into the aerobic-anoxic zones 151 and 152, and the effluent is discharged via line 105. Optionally, a portion of the effluent can be fed in the anaerobic zone thus elutriating VFA into aerobic-anoxic zones and increasing stability of and improving hydrolysis of particulate (including biomass) and high molecular weight organics in anaerobic processes. A portion of the effluent can also be recycled back in the aerobic-anoxic zones for pH buffering or other purposes. FIGS. 17, 18, and 19 are optional designs of a partition in the system of FIGS. 15 and 16 that can be used instead or in combination with the movable baffle 92. FIG. 17 depicts a stationary baffle 171 made upon a foundation 170 and not reaching the top of the pond. The mixed liquor is transferred from zone 150 to zones 151 and/or 152 over the top of the baffle. The floating arm 54 is positioned flat on the top of the water. FIG. 18 is another optional design of a partition in the system of FIGS. 15 and 16, the baffle 172 extends above the water level and the line 54 is provided with an arch 174 over the baffle 172. The arch 174 may be supported by floats 175. The mixed liquid is transferred from zone 150 to zones 151 and/or 152 via opening(s) 173. FIG. 19 is yet another optional design of a partition in the system of FIGS. 15 and 16, wherein a floating baffle 176 with mixed liquor transfer means 178 is provided, the top of the baffle 176 is lifted up by floats 177 while the bottom is pulled to the pond bottom 55 by weights 99, the weights 99 outweigh the floats 177 and lay tight on the bottom. Optionally, the floats 177 and the weights 99 may be flexible. The flow of mixed liquor occurs over the baffle 176 and the floats 177. The arm 54 is positioned flat on the water surface above the baffle 176 and floats 177. More than one partition can be used in the system. The system can accommodate any and all functional treatment zones described in the U.S. Pat. Nos. 5,514,277, 5,514,278, 5,616,241, 5,798,043, 5,846,424, 5,919,367, 6,004,456, 6,015,496, 6,048,459, 6,220,822.

The described system efficiently reduces BOD, COD, SS, and nitrogen. The system can be further improved by providing recuperable oxidation-reduction species, such as iron, nickel, or cobalt ions with or without catalyst (such as manganese), and recuperable alkaline species such as calcium ions. These species provide abiotic effects such as pH and alkalinity control and reduction of nitrogen and phosphorus. The process rate, efficiency, and stability increase. The production of excess biomass is further reduced in such systems. The embodiment of FIGS. 15 and 16 is a very simple and exceptionally effective system for removal of organics and nutrients with very low energy demand and virtually no excess biomass. Sometimes, additional sections for cultivating (conditioning) methanogenic sludge and for sludge oxidation with cycling ferrous-ferric ions by using air oxidation and organics (including biomass) reduction can be used.. It should also be stressed that the efficiency of phosphorus removal in the present system with iron addition is much greater than had been previously taught due to oxidation-reduction and pH changes in the process steps included in the system.

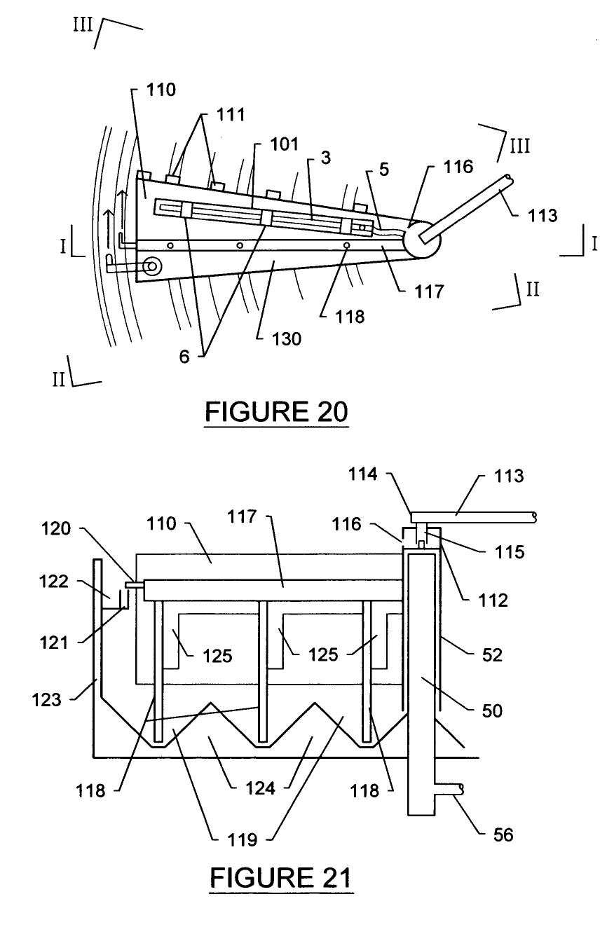

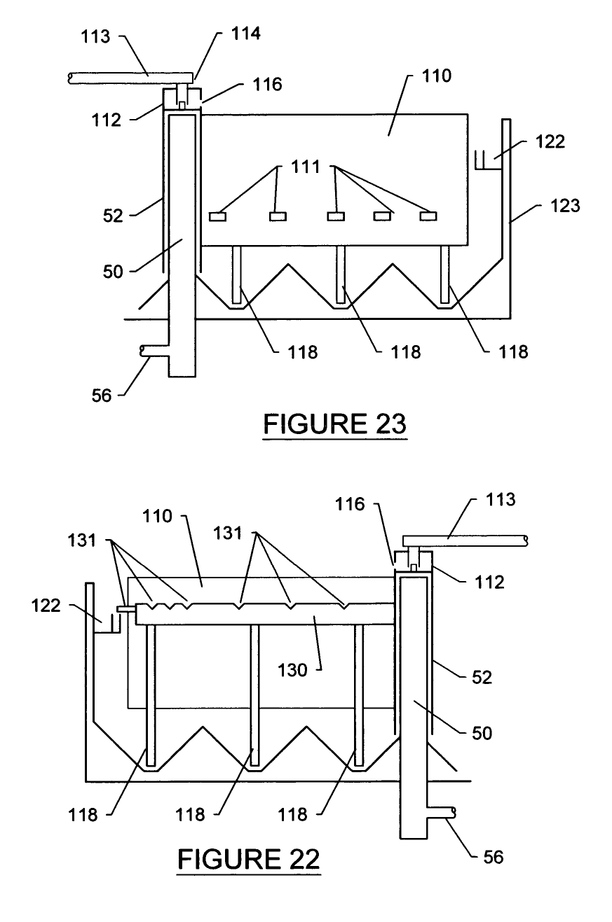

FIG. 20is a plan view and FIGS. 21, 22, and 23 are views along lines I-I, II-II, and III-III of a clarifier with self-propelled and pulsating devices for water distribution, effluent collection, and sludge evacuation. This apparatus is an improvement of an apparatus by I. V. Skirdov. The embodiment comprises a circular tank 123 with circular throughs 121 and 122 for collecting sludge and clarified water, and a bottom made of multiple circular ridges 124 and furrows 119. A central air pipe 50 with air feed 56 and a cap pipe 52 having a flexible air pipe 5 is provided. A section comprising a wedge-like effluent distribution box 110, a sludge collection flume 117, and an effluent collection flume 130 is provided. This section is rigidly or flexibly connected to the pipe 52. This section can optionally be supported by floats. The influent distribution box 110 houses a pulsator-aerator 101 with floats 6 (three floats are shown) and an air diffuser connected to the air feed pipe 5. The pulsator-aerator is similar to the devises described above effluent discharge ports 111 are provided at the lower portion of the influent distribution box 110. The sludge collection flume 117 is provided with airlifts 118 having the bottoms in the furrows 119 and the top attached to the flume 117. A line 120 is provided for discharging sludge into the sludge through 121. The flume 130 is provided with V-notch collection weirs (or other collection means, for example, orifices) and with a pipe 131 for discharging the clarified effluent in the effluent through 122. The influent line 113 is provided above all other structures in the system. It runs to the center of the cap pipe 52 and is supported at the center by a rotatable connection. A circular chamber 112 is provided at the top if pipe 52. The chamber 112 has an opening 116 disposed towards the influent distribution channel 110.

The embodiment of FIGS. 20, 21, 22, and 23 is operated as follows. The influent is provided via line 113 into chamber 112 and is further discharged into the distribution channel 110, wherein it is aerated and additionally flocculated with the help of the pulsator-aerator 101 as previously described. The influent is further directed out through the ports 111. The reactive force developed at the ports 111 propels the entire structure connected to the pipe 52 to rotate around pipe 50. The influent discharged via ports 111 is left to stay virtually quiescently in the body of the clarifier till the rotating structure makes a full 360 degrees turn. During this period, the sludge settles down and slides towards furrows 119. On the opposite side of the wedge-like section, the clarified liquid is collected via V-notches 131 into the flume 130 and is evacuated into the through 122 via pipe 131. Tangential discharge from pipe 131 produces additional rotating force. Air supplied through lines 125 to the airlifts 118 lifts the sludge from the furrows 119 into flume 117, from where the sludge is tangentially discharged into through 121 via pipe 120. Tangential sludge discharge produces additional driving force for the rotation of the wedge-like structure around pipe 50. Air from pipe 50 is “rotatably” delivered to airlifts 118 and to the pulsator-aerator 101.

While the invention has been described in detail with the particular reference to preferred embodiments, it will be understood that variations and modifications can be effected within the spirit and the scope of the invention as previously described and as defined by the claims.

1. A method for inducing pulsations in a system for treating materials comprising at least one liquid, said system comprising at least one float positioned at the top of said liquid, a gas distribution means for emitting gas in form of bubbles in said liquid, said gas distribution means is positioned underneath said at least one float and braced to said at least one float by at least one brace, said gas distribution means is connected to a source of gas by a conduit having at least one flexible part, said method comprising steps of (a) emitting gas at a predetermined initial flow rate from a gas distribution means in said liquid and producing a gas-liquid mixture having density less than the density of said liquid, (b) at least partially sinking said at least one float in said mixture whereby said gas distribution means is submerged to a greater depth and said gas flow rate at said greater depth is reduced and said density of said mixture increases, (c) at least partially rising said floats in said mixture and increasing said gas flow rate, and repeating steps (b) and (c), whereby rising and sinking of said at least one float produces pulsations of said gas distribution means within the range of pulsations, wave-like emission of said gas bubbles, and pulsating motion of said liquid in said system, and whereby said floats and said diffusion means pulsate within a range of pulsations.

2. A method of pulsating reacting mixtures in an apparatus with at least one float and at least one gas diffusion means disposed under said float and connected to said float by at least one brace, said diffusion means is flexibly connected to a source of gas, comprising steps of alternating sinking and floating of said float and said diffuser, whereby the rate of gas emission by said diffusion means increases at the upper positions, within the range of pulsation of the float and diffusion means thus decreasing the density of the liquid-gas mixture and causing the float and diffusion means to sink, and the rate of gas emission by said diffusion means decreases at the lower positions, within the range of pulsation, of the float and diffuser thus decreasing the density of the liquid-gas mixture and causing the float and diffuser to rise.

3. The method of claim 1, wherein said reacting is selected from the group of mass transfer, chemical and biological transformations, phase separations, thickening of suspensions, mixing, suspending of particles, washing, coagulation-flocculation, membrane filtration, filtration across particulate media, filtration across floating media, mass transfer across membrane, and combinations thereof.

4. The method of claim 3, wherein said mass transfer processes are selected from the group comprising gas absorption, gas desorption, aeration, deaeration, adsorption with granular adsorbent, adsorption with powdered adsorbent, adsorption by biomass, ion exchange, extraction, and combinations thereof.

5. The method of claim 3, wherein said chemical transformations are selected from the group comprising precipitation, crystallization, dissolution, oxidation-reduction, acid-base conversions, substitution, hydrolysis, polymerization, and combinations thereof.

6. The method of claim 5, wherein said oxidation-reduction steps are selected from the group comprising chemical oxidation-reduction steps, electrochemical oxidation-reduction steps, biological oxidation-reduction steps, and combinations thereof.

7. The method of claim 3, wherein said biological transformations are selected from the group comprising strictly anaerobic processes, methanogenic processes, sulfur reduction processes, ferric ion reduction processes, fermentation processes, acidification processes, denitrification processes, microaerofilic processes, air based aerobic processes, ferrous iron oxidation processes, nitrification processes, oxygen based aerobic processes, and combinations thereof.

8. The method of claim 3, wherein said mass transfer processes are selected from the group comprising gas absorption, gas desorption, adsorption with granular adsorbent, adsorption with powdered adsorbent, adsorption by biomass, ion exchange, extraction, and combinations thereof.

9. The method of claim 3, wherein said phase separation is selected from the group comprising gravity settling, suspended sludge blanket separation, fluidized bed separation, flotation, and combinations thereof.

10. The method of claim 3, wherein said membrane filtration is selected from the group comprising filtration with hollow fiber membranes, filtration with flat membranes, filtration with nanomembranes, filtration with microfilter membranes, and combinations thereof.

11. The method of claim 1, wherein said gas is selected from the group of air, oxygen, nitrogen, nitrogen oxides, inert gases, carbon dioxide, carbon monoxide, sulfur dioxide, hydrogen sulfide, ammonia, chlorine, ozone, organic gases, methane, fuel gas, propane, water vapor, steam, low pressure water vapor under vacuum, and combinations thereof.

12. The method of claim 1, wherein said source of gas is selected from the group comprising compressors, blowers, vacuum compressors, vacuum blowers, jet vacuum means, jet compression means, tanks with compressed gas, and combinations thereof.

13. The method of claim 1, wherein said range of pulsations is determined by factors selected from the group comprising a specific carrying capacity of said floats, said gas emission rate, hydraulic characteristic of said source of gas, said conduit, riser, and diffusion means, mass and inertia of said system, and combinations thereof.

14. The method of claim 5, wherein said specific carrying capacity of said floats increases (decreases) when ratio width to height in the vertical cross-section of said floats increases (decreases), whereby said range of pulsations is reduced (increased).

15. The method of claim 1, wherein said vertical cross-section of said floats is selected from the group comprising round section, vertically elongated section, vertically elongated rectangular section, vertically tapered section with wider top, vertically tapered section with wider bottom, vertically flat section, sections with openings, sections with holes, and combinations thereof whereby the range and the frequency of pulsations are determined by said selected cross-sections.

16. The method of claim 1, wherein multiple said systems are used simultaneously.

17. The method of claim 1, and further providing a step of self-propulsion by providing asymmetrical discharge of said liquid from said system of said system, whereby said step of self-propulsion is selected from a group comprising circular motion of said system, linear motion of said system, reciprocal motion of said system, motion along a predetermined curve, and combination thereof.

18. The method of claim 17, wherein said step of circular motion comprises steps of feeding said gas from the bottom of a vertical standpipe with at least one opening at the top, said vertical stand pipe is cupped with a vertical pipe having open bottom and closed top and at least one side branch for conducting said gas to said system, said system having said asymmetrical discharge in a predominantely tangential direction relative said circular motion, whereby said cupping pipe with said branch and said system freely rotate around said vertical standpipe.

19. The method of claim 17, wherein said step of reciprocal motion is provided by alternating steps of terminal switching of said asymmetrical discharge in opposite directions.

20. The method of claim 17, wherein said self-propelled motion is directed along directing means, whereby said directing means are selected from the group comprising a pivotal structure and at least one arm with said at least one system secured to said arm, at least one linear rail, at least one curvilinear rail, at least one closed line rail, at least one linear cable, at least one curvilinear cable, at least one closed line cable, and combinations thereof.

21. An apparatus for producing pulsation motion in at least one liquid being treated comprising at least one float, at least one gas diffuser, said diffuser is flexibly connected to a source of said gas, said gas is emitted from said diffuser in form of bubbles floating up along a predominantly vertical path wherein said diffuser is connected to said float by at last one brace, and said at least one float is positioned in said path of bubbles emitted by said diffuser, whereby said gas and said liquid produce a gas liquid mixture with varying density and said float and said diffuser are alternatingly sinking and rising in a pulsating manner, whereby said apparatus is used in conjunction with said treatment selected from a group comprising mass transfer, chemical and biological transformations, phase separations, thickening of suspensions, mixing, suspending of particles, washing, coagulation-flocculation, membrane filtration, filtration across particulate media, filtration across floating media, mass transfer across membrane, and combinations thereof.
